(19) United States
(12) Patent Application Publication
(10) Pub. No.: US 2021/0303990 A1
(43) Pub. Date: Sep. 30, 2021

(54) QUERY AND ANSWER DIALOGUE COMPUTER

(71) Applicant: Robert Bosch GmbH, Stuttgart (DE)

(72) Inventors: Alessandro OLTRAMARI, Pittsburgh, PA (US); Jonathan FRANCIS, Pittsburgh, PA (US)

(21) Appl. No.: 16/835,420

(22) Filed: Mar. 31, 2020

(51) Int. Cl. G06N 3/08; G06F 16/33; G06N 3/04; G06F 16/24; G06F 40/20

(52) U.S. Cl. CPC G06N 3/08; G06F 16/33; G06F 40/20; G06F 16/24; G06N 3/0472

(57) ABSTRACT

A dialogue computer and method of using the dialogue computer is disclosed. The method may comprise: receiving a query from a user; providing the query to an input layer of a neural network; injecting one or more triples of a knowledge graph into a plurality of nodes of an output layer of the neural network; and determining an answer to the query based on the output layer.

### TECHNICAL FIELD

The present disclosure relates to computational methods and computer systems for determining an answer in response to a query.

### BACKGROUND

Question-answer models can employ large question-answer datasets to enable a computer, when provided a question, to provide an answer. Due to a variety of linguistic contexts, these models lack a commonsense approach. Accordingly, they yield an undesirable percentage of inaccurate answers.

### SUMMARY

According to one embodiment, a method is disclosed that uses a dialogue computer. The dialogue computer may comprise: receiving a query from a user; providing the query to an input layer of a neural network; injecting one or more triples of a knowledge graph into a plurality of nodes of an output layer of the neural network; and determining an answer to the query based on the output layer.

According to another embodiment, a non-transitory computer-readable medium comprising computer-executable instructions and a memory for maintaining the computer-executable instructions is disclosed. The computer-executable instructions when executed by one or more processors of a computer may perform the following functions: receive a query from a user; provide the query to an input layer of a neural network; inject one or more triples of a knowledge graph into a plurality of nodes of an output layer of the neural network; and determine an answer to the query based on the output layer.

According to another embodiment, a dialogue computer is disclosed. The dialogue computer may comprise: one or more processors; and memory coupled to the one or more processors storing a plurality of instructions executable by the one or more processors, the plurality of instructions comprising to: receive a query from a user; provide the query to an input layer of a neural network; inject one or more triples of a knowledge graph into a plurality of nodes of an output layer of the neural network; and determine an answer to the query based on the output layer.

According to the at least one example set forth above, a computing device comprising at least one processor and memory is disclosed that is programmed to execute any combination of the examples of the method(s) set forth herein.

According to the at least one example, a computer program product is disclosed that includes a computer readable medium that stores instructions which are executable by a computer processor, wherein the instructions of the computer program product include any combination of the examples of the method(s) set forth herein and/or any combination of the instructions executable by the one or more processors, as set forth herein.

### BRIEF DESCRIPTION OF THE DRAWINGS

FIG. 1 is a schematic diagram of an example of a question and answer system that comprises a human-machine interface (HMI) and a dialogue computer.

FIG. 2 is a schematic diagram of an embodiment of the dialogue computer.

FIG. 3 is a schematic diagram of an embodiment of the question and answer system wherein the HMI is a kiosk.

FIG. 4 is a process flow diagram illustrating how the question and answer system can provide an answer to a user query.

FIG. 5 illustrates an example of a language model that may be used by the question and answer system.

FIG. 6 is a flowchart illustrating an embodiment of training the language model.

FIG. 7 is a flowchart illustrating an embodiment of using the question and answer system to provide an answer to a user query.

FIG. 8 is a schematic diagram illustrating another embodiment of the question and answer system wherein a kiosk comprises the HMI and the dialogue computer.

FIG. 9 is a schematic diagram illustrating an embodiment of the question and answer system wherein a vehicle comprises the HMI and the dialogue computer.

FIG. 10 is a schematic diagram illustrating an embodiment of the question and answer system wherein an enclosure located in a residence comprises the HMI and the dialogue computer.

FIG. 11 is a schematic diagram illustrating an embodiment of the question and answer system wherein a robotic machine comprises the HMI and the dialogue computer.

FIG. 12 is a schematic diagram illustrating an embodiment of the question and answer system wherein a telephonic device comprises the HMI and the dialogue computer.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

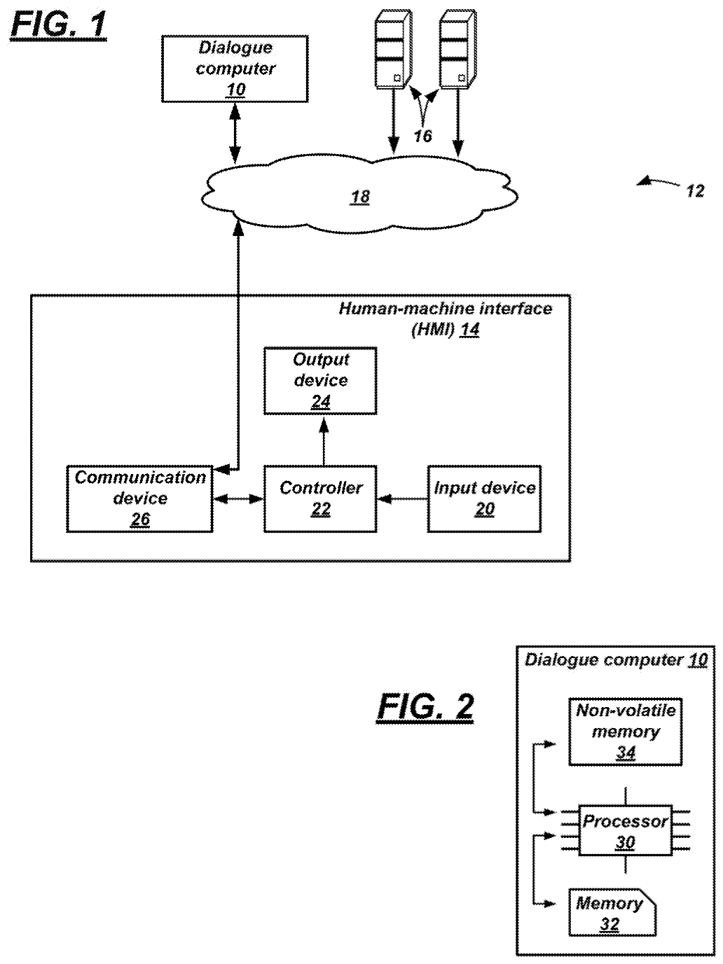

Turning now to the figures, wherein like reference numerals indicate like or similar features and/or functions, a dialogue computer 10 is shown for generating an answer to a query or question posed by a user (not shown). According to an example, FIG. 1 illustrates a question and answer (Q&A) system 12 that comprises a human-machine interface (HMI) 14 for the user, one or more storage media devices 16 (two are shown by way of example only), the dialogue computer 10, and a communication network 18 that may facilitate data communication between the HMI 14, the storage media devices 16, and the dialogue computer 10. As will be explained in detail below, the user may provide his/her query via text, speech, or the like using HMI 14, and the query may be transmitted to dialogue computer 10 (e.g., via communication network 18). Upon receipt, the dialogue computer 10 may utilize a hybrid language model to generate a response to the user—i.e., a model which employs both a data-oriented approach as well as knowledge-oriented approach. Using the hybrid language model improves question and answer accuracy, as solely data-oriented language models may be difficult to interpret and may be ill-equipped to incorporate a common-sense approach and as solely knowledge-oriented language models may lack an ability to estimate a statistical salience of a determination. The dialogue computer 10 described herein improves the user experience—e.g., by providing more accurate responses to user queries, users are less likely to become frustrated with a system that provides a computer-generated response.

A user of the Q&A system 12 may be a human being which communicates a query (a.k.a., a question) with a desire to receive a corresponding response. According to one embodiment, the query may regard any suitable subject matter. In other embodiments, the query may pertain to a predefined category of information (e.g., customer technical support for a product or service). These are merely examples; other embodiments also exist and are contemplated herein. An example process of providing an answer to a user's query will be described following a description of illustrative elements of system 12.

Human-machine interface (HMI) 14 may comprise any suitable electronic input-output device which is capable of: receiving a query from a user, communicating with dialogue computer 10 in response to the query, receiving an answer from dialogue computer 10, and in response, providing the answer to the user. According to the illustrated example of FIG. 1, the HMI 14 may comprise an input device 20, a controller 22, an output device 24, and a communication device 26.

Input device 20 may comprise one or more electronic input components for receiving a query from the user. Non-limiting examples of input components include: a microphone, a keyboard, a camera or sensor, an electronic touch screen, switches, knobs, or other hand-operated controls, and the like. Thus, via the input device 20, HMI 14 may receive the query from user via any suitable communication format—e.g., in the form of typed text, uttered speech, user-selected symbols, image data (e.g., camera or video data), sign-language, a combination thereof, or the like. Further, the query may be received in any suitable language.

Controller 22 may be any electronic control circuit configured to interact with and/or control the input device 20, the output device 24, and/or the communication device 26. It may comprise a microprocessor, a field-programmable gate array (FPGA), or the like; however, in some examples only discrete circuit elements are used. According to an example, controller 22 may utilize any suitable software as well (e.g., non-limiting examples include: DialogFlow™, a Microsoft chatbot framework, and Cognigy™). While not shown here, in some implementations, the dialogue computer 10 may communicate directly with controller 22. Further, in at least one example, controller 22 may be programmed with software instructions that comprise—in response to receiving at least some image data—determining user gestures and reading the user's lips. The controller 22 may provide the query to the dialogue computer 10 via the communication device 26. In some instances, the controller 22 may extract portions of the query and provide these portions to the dialogue computer 10—e.g., controller 22 may extract a subject of the sentence, a predicate of the sentence, an action of the sentence, a direct object of the sentence, etc.

Output device 24 may comprise one or more electronic output components for presenting an answer to the user, wherein the answer corresponds with a query received via the input device 20. Non-limiting examples of output components include: a loudspeaker, an electronic display, or the like. In this manner, when the dialogue computer 10 provides an answer to the query, HMI 14 may use the output device 24 to present the answer to the user according to any suitable format. Non-limiting examples include presenting the user with the answer in the form of audible speech, displayed text, one or more symbol images, a sign language video clip, or a combination thereof.

Communication device 26 may comprise any electronic hardware necessary to facilitate communication between dialogue computer 10 and at least one of controller 22, input device 20, or output device 24. Non-limiting examples of communication device 26 include a router, a modem, a cellular chipset, a satellite chipset, a short-range wireless chipset (e.g., facilitating Wi-Fi, Bluetooth, or the like), or a combination thereof. In at least one example, the communication device 26 is optional. E.g., dialogue computer 10 could communicate directly with the controller 22, input device 20, and/or output device 24.

Storage media devices 16 may be any suitable writable and/or non-writable storage media communicatively coupled to the dialogue computer 10. While two are shown in FIG. 1, more or fewer may be used in other embodiments. According to at least one example, the hardware of each storage media device 16 may be similar or identical to one another; however, this is not required. According to an example, storage media device(s) 16 may be (or form part of) a database, a computer server, a push or pull notification server, or the like. In at least one example, storage media device(s) 16 comprise non-volatile memory; however, in other examples, they may comprise volatile memory instead of or in combination with non-volatile memory. Storage media device(s) 16 (or other computer hardware associated with devices 16) may be configured to provide data to dialogue computer 10 (e.g., via communication network 18). The data provided by storage media device(s) 16 may be structured data, unstructured data, or a combination thereof; however, in at least one embodiment, each storage media device 16 stores and/or communicates some type of unstructured data to dialogue computer 10.

Structured data may be data that is labeled and/or organized by field within an electronic record or electronic file. Non-limiting examples of structured data include a knowledge graph (e.g., having a plurality of nodes (each node defining a different subject matter domain), wherein some of the nodes are interconnected by at least one relation), a data array (an array of elements in a specific order), metadata (e.g., having a resource name, a resource description, a unique identifier, an author, and the like), a linked list (a linear collection of nodes of any type, wherein the nodes have a value and also may point to another node in the list), a tuple (an aggregate data structure), and an object (a structure that has fields and methods which operate on the data within the fields).

According to at least some examples, the knowledge graph may comprise one or more knowledge types. Non-limiting examples include: a declarative commonsense knowledge type (scope comprising factual knowledge; e.g., “the sky is blue,” “Paris is in France,” etc.); a taxonomic knowledge type (scope comprising classification; e.g., football players are athletes,” “cats are mammals,” etc.); a relational knowledge type (e.g., scope comprising relationships; e.g., “the nose is part of the head,” “handwriting requires a hand and a writing instrument,” etc.); a procedural knowledge type (scope comprising prescriptive knowledge, a.k.a., order of operations; e.g., “one needs an oven before baking cakes,” “the electricity should be disconnected while the switch is being repaired,” etc.); a sentiment knowledge type (scope comprising human sentiments; e.g., “rushing to the hospital makes people worried,” “being on vacation makes people relaxed,” etc.); and a metaphorical knowledge type (scope comprising idiomatic structures; e.g., “time flies,” “it's raining cats and dogs,” etc.).

Unstructured data may be information that is not organized in a pre-defined manner (i.e., which is not structured data). Non-limiting examples of unstructured data include text data, electronic mail (e-mail) data, social media data, internet forum data, image data, mobile device data, communication data, and media data, just to name a few. Text data may comprise word processing files, spreadsheet files, presentation files, message field information of e-mail files, data logs, etc. Electronic mail (e-mail) data may comprise any unstructured data of e-mail (e.g., a body of an e-mail message). Social media data may comprise information from commercial websites such as Facebook™, Twitter™, LinkedIn™, etc. Internet forum data (e.g., also called message board data) may comprise online discussion information (of a website) wherein the website presents saved written communications of forum users (these written communications may be organized or curated by topic); in some examples, forum data may comprise a question and one or more public answers (e.g., question and answer (Q&A) data). Of course, Q&A data may form parts of other data types as well. Image data may comprise information from commercial websites such as YouTube′, Instagram™, other photo-sharing sites, and the like. Mobile device data may comprise Short Message System (SMS) or other short message data, mobile device location data, etc. Communication data may comprise chat data, instant message data, phone recording data, collaborative software data, etc. And media data may comprise Motion Pictures Expert Group (MPEG) Audio Layer Ills (MP3s), digital photos, audio files, video files (e.g., including video clips (e.g., a series of one or more frames of a video file)), etc.; and some media data may overlap with image data. These are merely examples of unstructured data; other examples also exist. Further, these and other suitable types of unstructured data may be received by the dialogue computer 10—receipt may occur concurrently or otherwise.

As shown in FIGS. 1 and 2, dialogue computer 10 may be any suitable computing device that is programmed or otherwise configured to receive a query from the input device 20 (e.g., from HMI 14) and provide an answer using a neural network that employs a hybrid language model (i.e., a combination of a data-oriented language model and a knowledge-oriented language model). System 10 may comprise any suitable computing components. According to an example, dialogue computer 10 comprises one or more processors 30 (only one is shown in the diagram for purposes of illustration), memory 32 that may store data received from the user and/or the storage media devices 16, and non-volatile memory 34 that may store data and/or a plurality of instructions executable by processor(s) 30.

Processor(s) 30 may be programmed to process and/or execute digital instructions to carry out at least some of the tasks described herein. Non-limiting examples of processor(s) 30 include one or more of a microprocessor, a microcontroller or controller, an application specific integrated circuit (ASIC), a field-programmable gate array (FPGA), one or more electrical circuits comprising discrete digital and/or analog electronic components arranged to perform predetermined tasks or instructions, etc.—just to name a few. In at least one example, processor(s) 30 read from memory 32 and/or non-volatile memory 34 and execute multiple sets of instructions which may be embodied as a computer program product stored on a non-transitory computer-readable storage medium (e.g., such as in non-volatile memory 34). Some non-limiting examples of instructions are described in the process(es) below and illustrated in the drawings. These and other instructions may be executed in any suitable sequence unless otherwise stated. The instructions and the example processes described below are merely embodiments and are not intended to be limiting.

Memory 32 may include any non-transitory computer usable or readable medium, which may include one or more storage devices or storage articles. Exemplary non-transitory computer usable storage devices include conventional hard disk, solid-state memory, random access memory (RAM), read-only memory (ROM), erasable programmable read-only memory (EPROM), electrically erasable programmable read-only memory (EEPROM), as well as any other volatile or non-volatile media. Non-volatile media include, for example, optical or magnetic disks and other persistent memory, and volatile media, for example, also may include dynamic random-access memory (DRAM). These storage devices are non-limiting examples; e.g., other forms of computer-readable media exist and include magnetic media, compact disc ROM (CD-ROMs), digital video disc (DVDs), other optical media, any suitable memory chip or cartridge, or any other medium from which a computer can read. As discussed above, memory 32 may store one or more sets of instructions which may be embodied as software, firmware, or other suitable programming instructions executable by the processor(s) 30—including but not limited to the instruction examples set forth herein. In operation, processor(s) 30 may read data from and/or write data to memory 32.

Non-volatile memory 34 may comprise ROM, EPROM, EEPROM, CD-ROM, DVD, and other suitable non-volatile memory devices. Further, as memory 32 may comprise both volatile and non-volatile memory devices, in at least one example additional non-volatile memory 34 may be optional.

FIG. 1 illustrates an example of HMI 14 that does not comprise dialogue computer 10; e.g., wherein dialogue computer 10 is remote from HMI 14. However, as will be explained more below, in some embodiments, dialogue computer 10 may be part of the HMI 14 as well. In these examples, having dialogue computer local to and even sometimes within a common housing of the HMI 14 enables portable implementations (which will be discussed more below).

Communication network 18 facilitates electronic communication between dialogue computer 10, the storage media device(s) 16, and HMI 14. Communication network 18 may comprise a land network, a wireless network, or a combination thereof. For example, the land network may enable connectivity to public switched telephone network (PSTN) such as that used to provide hardwired telephony, packet-switched data communications, internet infrastructure, and the like. And for example, the wireless network may comprise cellular and/or satellite communication architecture covering potentially a wide geographic region. Thus, at least one example of a wireless communication network may comprise eNodeBs, serving gateways, base station transceivers, and the like.

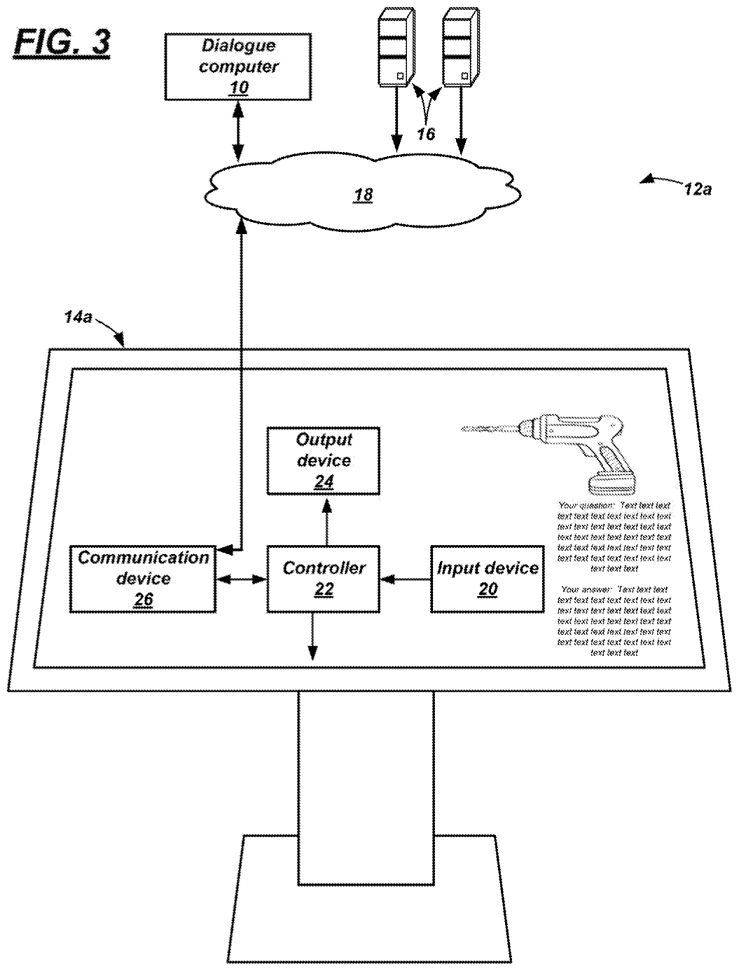

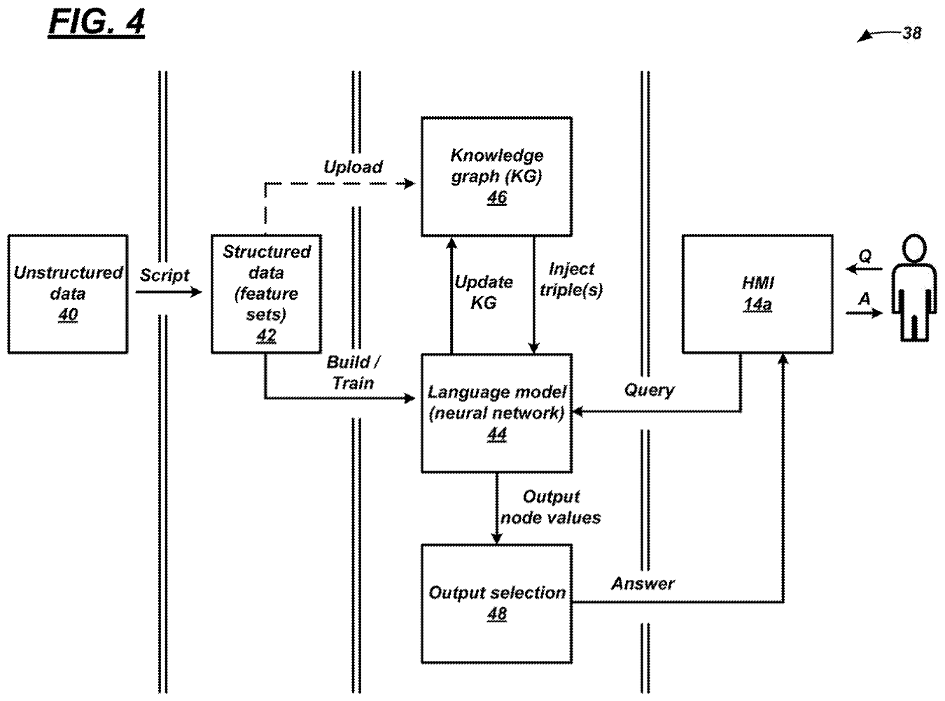

FIG. 3 illustrates one embodiment of a Q&A system 12a. Herein, reference numerals 12a, 12b, 12c, . . . , etc. indicate different and non-limiting embodiments of the Q&A system 12 shown in FIG. 1. Similarly, reference numerals 14a, 14b, 14c, . . . , etc. indicate different and non-limiting embodiments of the HMI 14. According to the illustrated embodiment, system 12a comprises an HMI 14a that includes the input device 20, the controller 22, the output device 24, and the communication device 26, wherein HMI 14a is arranged within a common housing as a kiosk (also referred to as a terminal). According to an example, HMI 14a may be configured and/or programmed to provide product or service information to a user, and when the user poses a query to the HMI 14a (e.g., via speech, typed text, or the like), the HMI 14a may provide an accurate answer using dialogue computer 10 which may be located remotely from HMI 14a. This is merely one example and is used to illustrate the processes shown and described in FIGS. 4, 5, and 6.

FIG. 4 is a schematic diagram illustrating an embodiment of a process flow 38 of the Q&A system 12 (e.g., which may be used generally by all embodiments of Q&A system). Process flow 38 includes dialogue computer 10 receiving unstructured data 40 from storage media device(s) 16. Numerous examples of unstructured data were provided above and could be used in this example; for the sake of brevity, consider the unstructured data in this example to comprise Q&A data, internet forum data, image data, and e-mail data. Dialogue computer 10 may execute a script (e.g., stored in non-volatile memory 34) which organizes this unstructured data 40 into structured data 42. For example, the script may format, normalize, etc. the structured data into feature sets.

According to at least one example, the structured data 42 comprises at least a question-and-answer (Q&A) pair feature set. The Q&A pair feature set may be provided to a language model 44 stored in non-volatile memory 34 and executed using processor(s) 30 of dialogue computer 10. The language model 44 may be a neural network configured to receive a query (e.g., a query in the form of an interrogative sentence) and provide an answer (e.g., in the form of a declarative sentence). In some examples, dialogue computer 10 further determines a metadata feature set (and/or other feature set) and also provides these set(s) to language model 44. Any combination of feature sets may be provided to the language model 44 so that the language model 44 may be built and trained thereby increasing the likelihood that the answer is accurate.

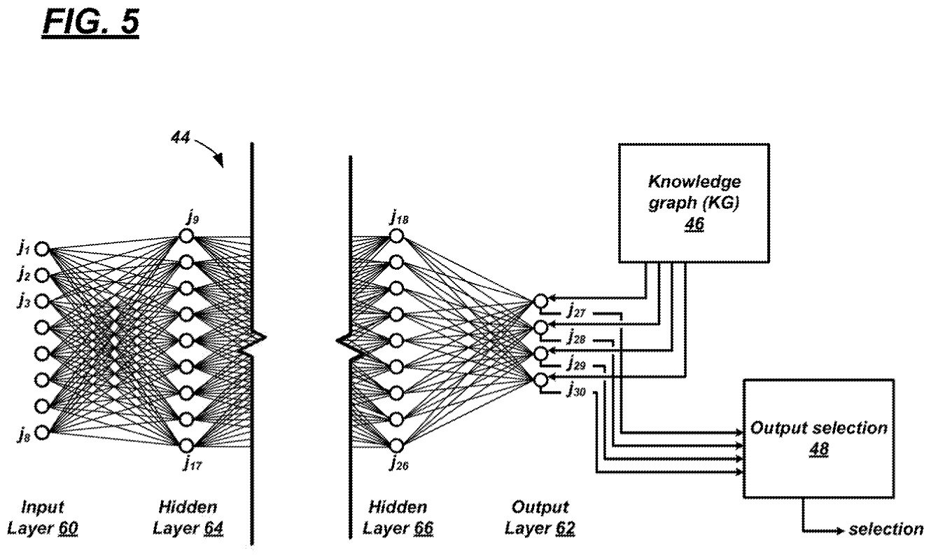

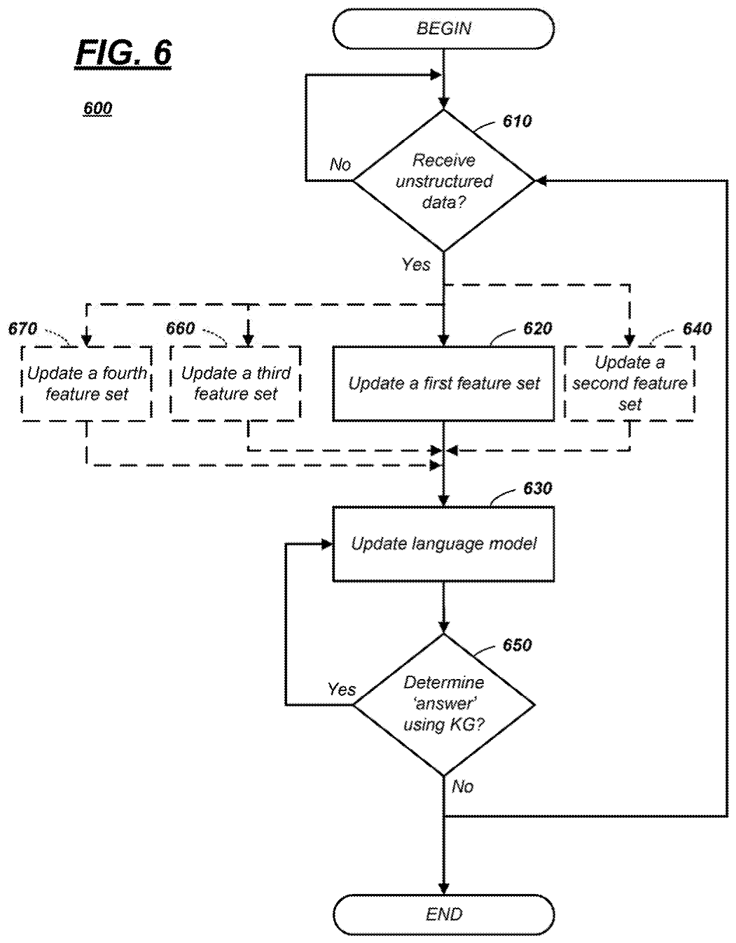

FIG. 5 illustrates an embodiment of language model 44. As discussed above, the language model 44 may be a neural network (e.g., and in some cases, while not required, a deep neural network). The language model 44 may be configured as a data-oriented language model that uses a data-oriented approach to determine an answer to a question. Language model 44 may comprise an input layer 60 (comprising a plurality of input nodes, e.g., j1 to j8) and an output layer 62 (comprising a plurality of output nodes, e.g., j27 to j30). The illustrated quantities of input and output nodes are merely examples; other quantities may be used instead. In some examples, language model 44 may comprise one or more hidden layers (e.g., such as an illustrated hidden layer 64 (comprising a plurality of hidden nodes j9 to j17) and an illustrated hidden layer 66 (comprising a plurality of hidden nodes j18 to j26)). The nodes of the layers 60, 62, 64, 66 may be coupled to nodes of subsequent or previous layers. And each of the nodes j27 to j30 of the output layer 62 may execute an activation function—e.g., a function that contributes to whether the respective nodes should be activated to provide an output of the language model 44 (e.g., based on its relevance to the answer to the query). The quantities of nodes shown in the input, hidden, and output layers 60, 64, 66, 62 of FIG. 5 is merely an example; any suitable quantities may be used.

Returning to FIG. 4, in at least one example, dialogue computer 10 also organizes the unstructured data 40 into a knowledge graph feature set and provides it (e.g., uploads it) to a knowledge graph 46. The knowledge graph feature set may comprise one or more of: a declarative commonsense knowledge type, a taxonomic knowledge type, a relational knowledge type, a procedural knowledge type, a sentiment knowledge type, a metaphorical knowledge type, or any other suitable type. According to one embodiment, the knowledge graph 46 may form part of the programming of dialogue computer 10 (e.g., the computer 10 may host and manage the knowledge graph 46). According to another embodiment, the knowledge graph 46 is stored, managed, and controlled by a different computer (e.g., controlled by a third-party entity or the like). Regardless, the knowledge graph feature set (determined by dialogue computer 10) may be imported into knowledge graph 46 to improve its accuracy.

The various knowledge types of the knowledge graph 46 may be comprised of triples which are interconnected to form data structure. According to an example, a triple may comprise a subject element, a relationship element, and an object element. According to an example, knowledge graph 46 may be configured to improve the answer determination of the language model 44—e.g., the triples may comprise a subject of a sentence (subject element), a predicate of a sentence (relationship element), and an object of the sentence (object element), wherein the object is part of the predicate of the sentence. Accordingly, potentially millions of subject elements could be linked to different object elements via respective relationship elements. Each of the subject, relationship, and object elements may be assigned a value; e.g., each triple may be represented as a mathematical vector. In this manner, the triple may be utilized by the language model 44.

As shown in FIGS. 4 and 5, the triples may be injected into the language model 44 to assist in the determination of an answer to the user's query. More particularly, as shown by way of example in FIG. 5, one or more triples may be injected into each of the output nodes j27-j30 of the output layer 62. And based on a calculation in the output nodes of the language model 44, these triples may alter a value outputted by the activation function of the respective output nodes. Further, FIG. 5 illustrates each of the output nodes j27-j30 receiving an injection; this is merely an example. For instance, in other examples, some or all of the output nodes may be injected with triples from the knowledge graph 46.

Thus, as shown in FIG. 4, when the HMI 14a receives a query (e.g., question Q) from a user and the query is delivered to the language model 44, the query may be received at the input layer 60 and pass through neural network—being evaluated using a data-oriented language model. However, once the dialogue computer 10 injects one or more triples into the output layer 62 of the neural network, the answer generated by language model 44 may be influenced by a knowledge-oriented approach. Accordingly, the example shown in FIGS. 4-5 is a hybrid language model.

According to an example (see FIGS. 4-5), output node values of at least some of the output nodes j27-j30 are provided to an output selection 48. Output selection 48 is configured to determine which of the answers provided by the output nodes should be selected as an answer the user's query. According to at least one non-limiting example, processor(s) 30 of dialogue computer 10 select the output node which has a highest probability value of a probability distribution. Thus, output selection 48 may be an electrical circuit which determines a highest probability value, software or firmware which determines the highest probability value, or a combination thereof.

Once the answer is selected, the answer is provided to HMI 14a. As described above, via at least one output device 24, the user is presented with the answer (A). Thus, continuing with the example above, a user may approach HMI 14a (e.g., a kiosk), utter or type a query via the input device 20, the controller 22 may provide it to the communication device 26, the communication device 26 may transmit it to the dialogue computer 10, the dialogue computer 10 may execute the hybrid language model (as described above), upon determination of an answer to the query, the dialogue computer 10 may provide the answer to the communication device 26, the communication device 26 may provide the answer to the controller 22, and the controller 22 may provide the answer to the output device 24, wherein the output device 24 may provide the answer audibly or by otherwise presenting via display.

Turning now to FIG. 6, a process 600 is illustrated describing a technique for building and training the language model 44. Process 600 is illustrated with a plurality of instructional blocks which may be executed by the one or more processors 30 of dialogue computer 10. The process may begin with block 610.

In block 610, computer 10 may determine whether it is receiving unstructured data—e.g., from storage media devices 16 or the like. If computer 10 is receiving unstructured data, the process may proceed to block 620; otherwise, it may loop back and repeat block 610. It should be appreciated that unstructured data could be received in other ways as well; e.g., initially, a quantity of unstructured data could be moved from a network drive to memory 32 (and/or memory 34).

In block 620, computer 10 may update a first feature set. According to an example, the first feature set could be a Q&A pair feature set, as described above. For example, dialogue computer 10 may parse the unstructured data received in block 610 and organize the data into structured data, such as the Q&A pair feature set. According to at least one example, the Q&A pair feature set is a data array; however, this is not required in all examples. Block 630 may follow.

As shown in FIG. 6, following block 610, an optional block 640 may be executed as well. In some examples, this occurs at least partially concurrently; however, this is not required. In block 640, computer 10 may update a second feature set. For example, dialogue computer 10 may parse the unstructured data received in block 610 and organize the data into structured data, such as the knowledge graph feature set. Block 630 may follow. In examples which do not include block 640, a knowledge graph still may be used; however, the knowledge graph may be hosted, managed, and maintained a third party (e.g., such as Google's™ knowledge graph or the like). In at least some examples, a third-party knowledge graph may be open source (OS) (e.g., such as ConceptNet™, ATOMIC™, or the like); accordingly, computer 10 could provide the second feature set to a respective third party which may permit that party to update the knowledge graph accordingly.

In block 630, computer 10 may update the language model 44 using the information of block 620. Updated structured data, once imported, may enable the language model 44 to be more refined and yield more accurate answers. Block 630 may or may not include addition of new neural network layers and/or neural network nodes in existing and/or new layers.

Blocks 610-640 may occur before a user approaches HMI 14a. In block 650, the computer 10 determines whether an ‘answer’ to a query has been determined using the knowledge graph 46 (e.g., abbreviated ‘KG’ in the figures). When no answer has been determined, process 600 may loop back to block 610 and continue to receive and process unstructured data to improve the language model 44, the knowledge graph 46, or both. (Alternatively, process 600 could end).

However, when an answer has been determined in block 650, process 600 may loop back and update the language model 44 in block 630. E.g., the nodes of the language model 44 may be tuned further using the answer derived using the injected triples of the language graph feature set. Block 650 may again follow, and then when no new answer is determined in block 650, process 600 may proceed to block 610, as previously described.

Other embodiments of process 600 also exist. For example, additional feature sets may be used to improve the language model. According to FIG. 6, computer 10 may determine a third feature set using unstructured data at block 660; e.g., this may be a metadata feature set. Also, computer 10 may determine a fourth feature set using unstructured data at block 670; e.g., this may be any other suitable feature set. Optional blocks 660 and/or 670 may be provided to the language model 44 in block 630—thereby improving its accuracy.

According to another embodiment, process 600 further may comprise training the language model using supervised learning. E.g., a query may be presented to the neural network which also comprises predetermined answers to the query so that the neural network will determine the correct answer. This process may be repeated until the accuracy of the neural network exceeds a predetermined threshold.

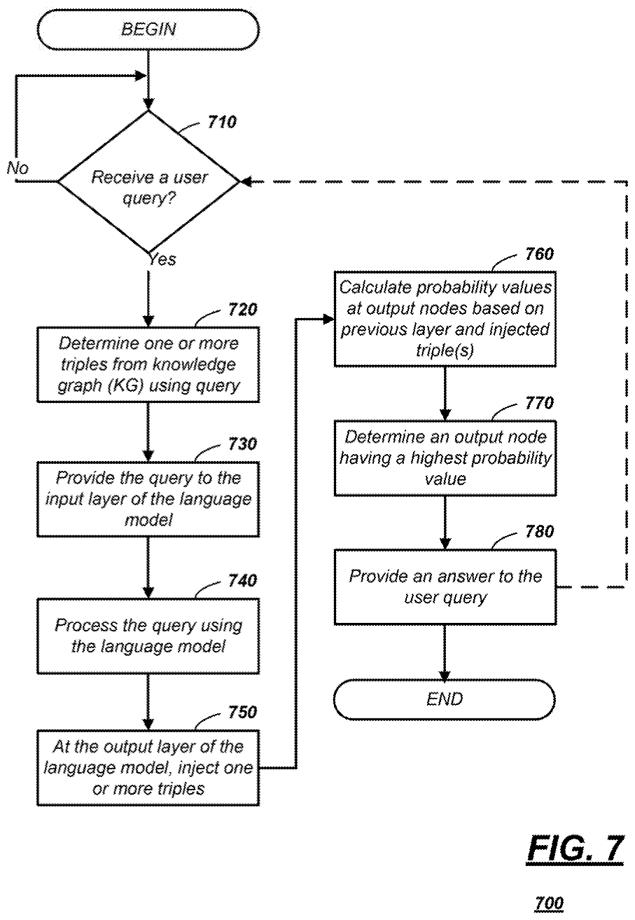

Turning now to FIG. 7, a process 700 is illustrated describing a technique for providing an answer to a user query using language model 44. Process 700 is illustrated with a plurality of instructional blocks which may be executed by the one or more processors 30 of dialogue computer 10 and/or by controller 22. The process may begin with block 710.

In block 710, computer 10 may determine whether a user query has been received. For example, a default state may be that no user query has been received; however, computer 10 may receive an indication from controller 22 (via communication device 26) that a query has been received. According to one non-limiting example, the user query may be a RESTful application program interface (API) request (REpresentational State Transfer Application Protocol Request) via Hyper Text Transfer Protocol Secure (HTTPS); however, other examples also exist (including but not limited to a Simple Object Access Protocol (SOAP) request).

According to another embodiment of block 710, controller 22 determines whether a query has been received from a user (e.g., via HMI 14a). When no query is determined to be received, process 700 may loop back and repeat block 710 until a query is received. Otherwise, the process may proceed to block 720.

In block 720, computer 10 may determine one or more triples from knowledge graph 46 using the query. According to a non-limiting example, the computer 10 may evaluate the query sentence, and based on the evaluation, computer 10 may determine at least one associated knowledge type (e.g., one of a declarative commonsense knowledge type, a taxonomic knowledge type, a relational knowledge type, a procedural knowledge type, a sentiment knowledge type, a metaphorical knowledge type, or other suitable type) and provide one or more triples from the knowledge graph 46 based on one or more appropriate knowledge types.

Block 730 may follow block 720, or may occur at least partially concurrently, or may even be executed before block 720. In block 730, computer 10 may provide the query to the language model 44. In some examples, the entire interrogative sentence is provided; in other examples, computer 10 parses the query and provides to the input layer 60 of language model 44 portions of the interrogative sentence.

In block 740, computer 10 may process the query using the language model 44. According to an example, node(s) of the various layers 60, 64, 66 of a neural network are activated. The output layer 62 may be processed in the blocks that follow.

Once the one or more triples are determined (block 720) and once the neural network is executed except for the output layer 62 (block 740), block 750 may be executed by computer 10. As shown in FIG. 5, the one or more triples may be injected into the nodes of the output layer 62 (e.g., such as into nodes j27-j30).

In block 760, computer 10—via language model 44—may calculate a probability value for at least some of the output nodes of the output layer 62. According to an example, this may be a matrix or vector calculation.

In block 770 which follows, computer 10 may determine which output node has the highest probability value (e.g., of a probability distribution). As discussed above, computer 10 may use output selection 48 to make this determination.

In block 780, computer 10 may determine an answer based on the output node having the highest probability value and provide this as an answer to the user query. According to one example, computer 10 may provide this to HMI 14a—via communication network 18 (e.g., as an asynchronous response via HTTPS). Communication device 26 may receive this answer and provide it to controller 22 which in turn may provide the answer to output device 24 so that the answer may be presented to the user. Thereafter, process 700 may end, or alternatively, process 700 may loop back to block 710 to repeat the process.

Other embodiments of process 700 also exist. For example, when the knowledge graph 46 is not stored at dialogue computer 10, computer 10 may transmit a request for the one or more triples, and the knowledge graph (e.g., being stored on a different computer or server) may transmit a response that comprises one or more triples.

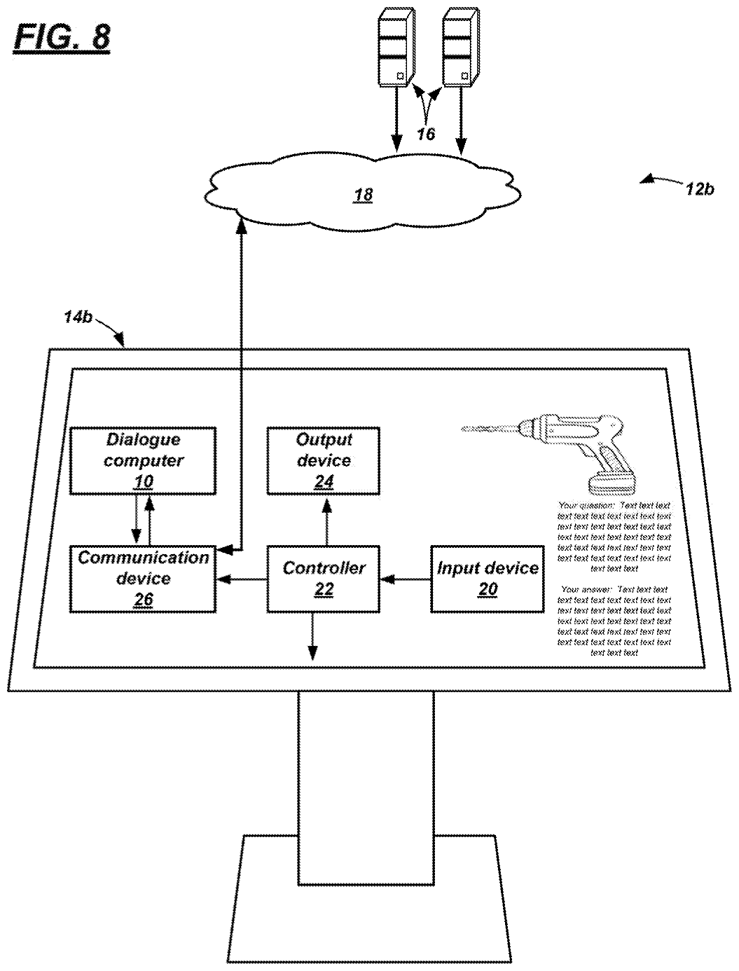

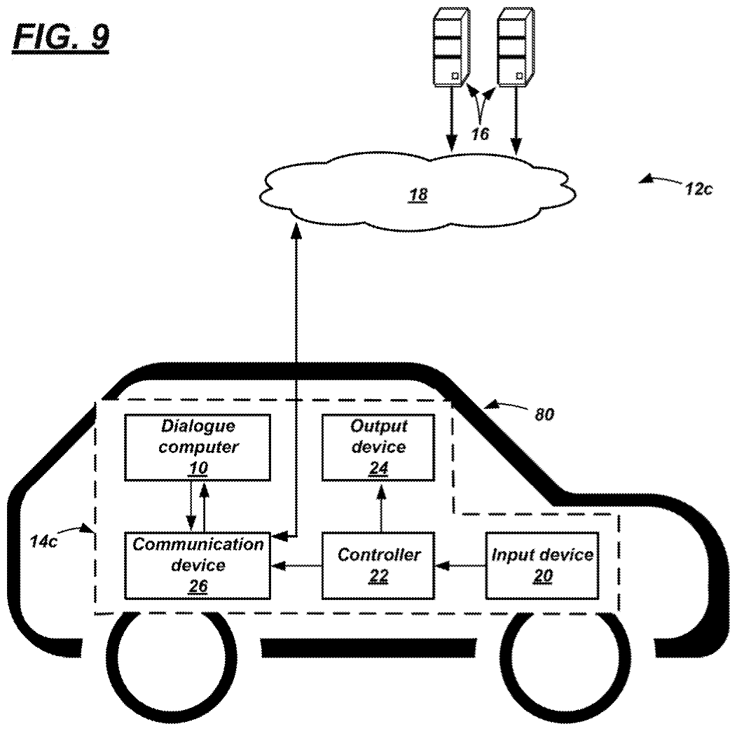

Now turning to FIG. 8, another embodiment of the Q&A system is shown (Q&A system 12b). Here, the dialogue computer 10 may be located within HMI 14b. Other aspects of the system 12b and its operation may be similar to that described above.

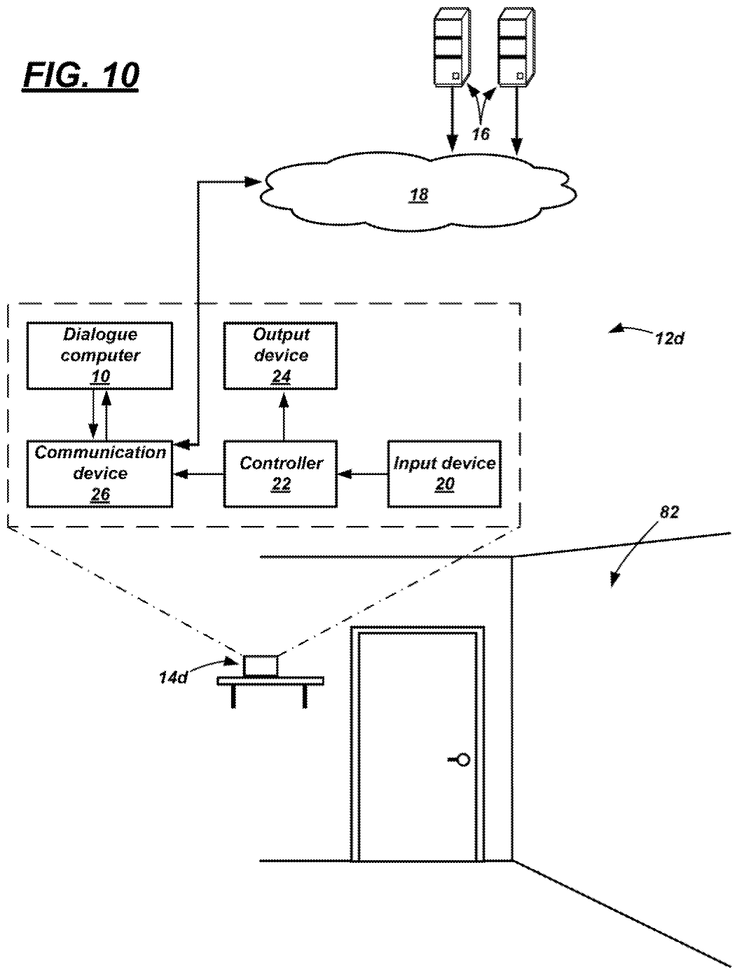

Now turning to FIG. 9, another embodiment of the Q&A system is shown (Q&A system 12c). Here, the dialogue computer 10 may be located within HMI 14c of a vehicle 80. Vehicle 80 may be a passenger vehicle, a pickup truck, a heavy-equipment vehicle, a watercraft, an aircraft, or the like. Other aspects of the system 12c and its operation may be similar to that described above. According to yet another embodiment, the dialogue computer 10 may be remotely located—e.g., not be located within HMI 14c.

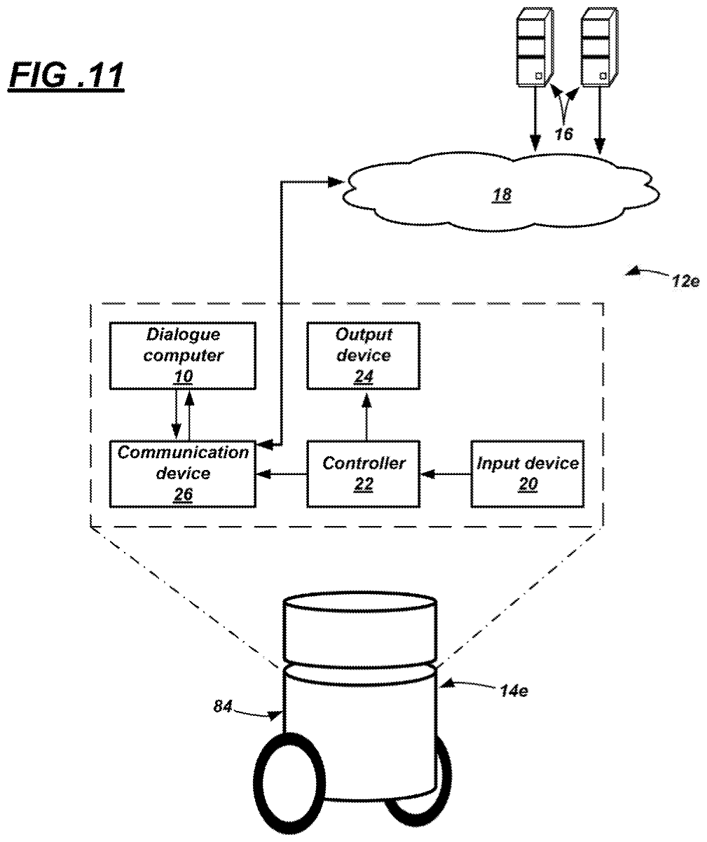

Now turning to FIG. 10, another embodiment of the Q&A system is shown (Q&A system 12d). Here, the dialogue computer 10 may be located within HMI 14d within a building 82 (e.g., a residence, a commercial building, or an industrial building). More particularly, HMI 14d is shown sitting on a shelf in a room of the building. Other aspects of the system 12c and its operation may be similar to that described above. According to yet another embodiment, the dialogue computer 10 may be remotely located—e.g., not be located within HMI 14d.

Now turning to FIG. 11, another embodiment of the Q&A system is shown (Q&A system 12e). Here, the dialogue computer 10 may be located within HMI 14e of a robotic machine 84. Robotic machine 84 may be any remotely controlled machine, partially autonomous, or fully autonomous robotic machine. Other aspects of the system 12e and its operation may be similar to that described above. According to yet another embodiment, the dialogue computer 10 may be remotely located—e.g., not be located within HMI 14e.

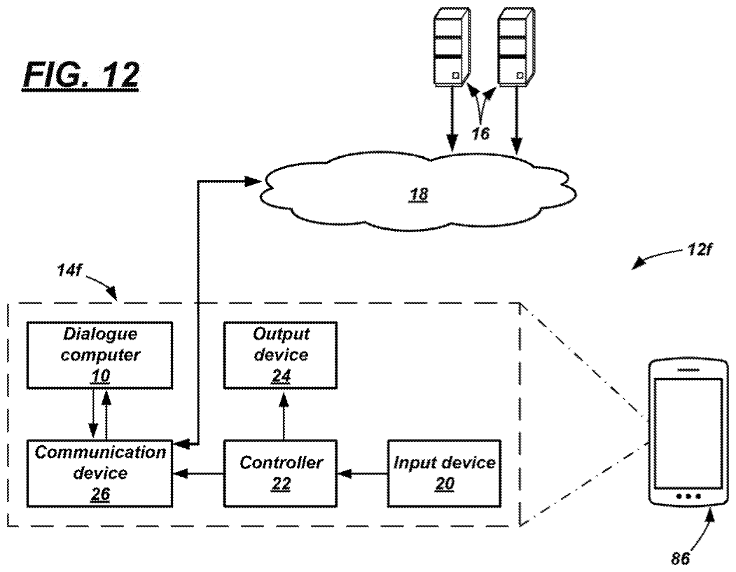

Now turning to FIG. 12, another embodiment of the Q&A system is shown (Q&A system 12f). Here, the dialogue computer 10 may be located within HMI 14f of a telephonic device 86 (e.g., a landline-based phone system, a cellular phone, a Smartphone, or the like). Other aspects of the system 12f and its operation may be similar to that described above. According to yet another embodiment, the dialogue computer 10 may be remotely located—e.g., not be located within HMI 14f.

Still other examples also exist. For example, knowledge graph 46 described above may be public or private. E.g., a private knowledge graph may comprise proprietary data known only to the entity which manufactures and sells the dialogue computer 10. In at least one example, the proprietary data may comprise personally identifiable information (PII); e.g., the dialogue computer 10 may be configured for a workplace environment.

Thus, there has been described a question and answer system that receives a query from a user, processes the query using a hybrid language model, and then provides an answer to the query. The hybrid language model may comprise aspects of a data-oriented language model and aspects of a knowledge-oriented language model. The hybrid language model may increase the accuracy of answers to user queries.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of using a dialogue computer, comprising:
receiving a query from a user;
providing the query to an input layer of a neural network;
injecting one or more triples of a knowledge graph into a plurality of nodes of an output layer of the neural network; and
determining an answer to the query based on the output layer.

2. The method of claim 1, wherein at least one of the input layer, the output layer, or a third layer of the neural network comprises evaluation of the query using a question-and-answer pair feature set, wherein the a question-and-answer pair feature set is structured data.

3. The method of claim 2, further comprising determining the question-and-answer pair feature set from a plurality of unstructured data.

4. The method of claim 3, wherein the plurality of unstructured data comprises at least one of electronic mail data, online forum data, question and answer data, image data, or metadata.

5. The method of claim 1, wherein injecting the one or more triples alters a calculation of respective activation functions of at least some of the plurality of nodes of the output layer.

6. The method of claim 1, wherein each of the one or more triples comprise a unique combination of a subject element, a relationship element, and an object element, wherein the subject element is associated with a subject of a sentence, the relationship element is associated with a predicate of the sentence, and the object element is associated with an object of the sentence.

7. The method of claim 1, wherein determining the answer further comprises: selecting an output node from among the plurality of nodes having a highest probability value of a probability distribution; and determining the answer based on the selected output node.

8. A non-transitory computer-readable medium comprising computer-executable instructions and a memory for maintaining the computer-executable instructions, the computer-executable instructions when executed by one or more processors of a computer perform the following functions:
receive a query from a user;
provide the query to an input layer of a neural network;
inject one or more triples of a knowledge graph into a plurality of nodes of an output layer of the neural network; and
determine an answer to the query based on the output layer.

9. The non-transitory computer-readable medium of claim 8, wherein at least one of the input layer, the output layer, or a third layer of the neural network comprises evaluation of the query using a question-and-answer pair feature set, wherein the question-and-answer pair feature set is structured data.

10. The non-transitory computer-readable medium of claim 9, wherein the instructions further comprises determining the question-and-answer pair feature set from a plurality of unstructured data.

11. The non-transitory computer-readable medium of claim 10, wherein the plurality of unstructured data comprises at least one of electronic mail data, internet forum data, question and answer data, video frame data, image data, or metadata.

12. The non-transitory computer-readable medium of claim 8, wherein injecting the one or more triples alters a calculation of respective activation functions of at least some of the plurality of nodes of the output layer.

13. The non-transitory computer-readable medium of claim 8, wherein each of the one or more triples comprise a unique combination of a subject element, a relationship element, and an object element, wherein the subject element is associated with a subject of a sentence, the relationship element is associated with a predicate of the sentence, and the object element is associated with an object of the sentence.

14. The non-transitory computer-readable medium of claim 8, wherein determining the answer further comprises: selecting an output node from among the plurality of nodes having a highest probability value of a probability distribution; and determining the answer based on the selected output node.

15. A dialogue computer, comprising:
one or more processors; and
memory coupled to the one or more processors storing a plurality of instructions executable by the one or more processors, the plurality of instructions comprising to:
receive a query from a user;
provide the query to an input layer of a neural network;
inject one or more triples of a knowledge graph into a plurality of nodes of an output layer of the neural network; and
determine an answer to the query based on the output layer.

16. The system of claim 15, wherein at least one of the input layer, the output layer, or a third layer of the neural network comprises evaluation of the query using a question-and-answer pair feature set, wherein the question-and-answer pair feature set is structured data.

17. The system of claim 16, further comprising determining the question-and-answer pair feature set from a plurality of unstructured data, wherein the plurality of unstructured data comprises at least one of electronic mail data, online forum data, question and answer data, image data, or metadata.

18. The system of claim 15, wherein injecting the one or more triples alters a calculation of respective activation functions of at least some of the plurality of nodes of the output layer.

19. The system of claim 15, wherein each of the one or more triples comprise a unique combination of a subject element, a relationship element, and an object element, wherein the subject element is associated with a subject of a sentence, the relationship element is associated with a predicate of the sentence, and the object element is associated with an object of the sentence.

20. The system of claim 15, wherein determining the answer further comprises: selecting an output node from among the plurality of nodes having a highest probability value of a probability distribution; and determining the answer based on the selected output node.
